(19) United States
(12) Patent Application Publication
(10) Pub. No.: US 2018/0278881 A1
(43) Pub. Date: Sep. 27, 2018

(54) MULTIPLE CAMERA-BASED IMAGE TRANSMISSION METHOD, DEVICE AND SYSTEM

(71) Applicant: CAFE24 CORP., Seoul (KR)

(72) Inventor: Jae Suk LEE, Seoul (KR)

(73) Assignee: CAFE24 CORP., Seoul (KR)

(21) Appl. No.: 15/552,494

(22) PCT Filed: Apr. 22, 2016
(86) PCT No.: PCT/KR2016/004207

§ 371 Date: Aug. 22, 2017

(30) Foreign Application Priority Data
Dec. 4, 2015 (KR) 10-2015-0172047
Jan. 12, 2016 (KR) 10-2016-0003558

(51) Int. Cl. H04N 5/445; H04N 5/247; H04N 5/44; G06F 3/01; H04L 29/06

(52) U.S. Cl. CPC H04N 5/44591; H04N 5/247; H04N 5/2253; G06F 3/013; H04L 65/4076; H04N 5/4403

(57) ABSTRACT

Disclosed are a multiple camera-based image transmission method, device and system. The image transmission method enables: acquiring multiple images by using multiple cameras; displaying a screen displayed on a monitor so as to be segmented into multiple areas corresponding to the multiple images; detecting an area at which a user is gazing; selecting the image that corresponds to the detected area; and transmitting the selected image via broadcasting. Thus, on the basis of multiple images, a broadcast image may be switched according to the gaze of a user.

### TECHNICAL FIELD

The present invention relates to an image transmission method, device and system based on a plurality of cameras and, more particularly, to an image transmission method, device and system based on a plurality of cameras, wherein a plurality of images is captured through a plurality of cameras and the captured images are selectively transmitted in response to a user's eyes.

### BACKGROUND ART

Recently, with the development of the live streaming technology, the user base of personal broadcasting based on the Internet is increasing rapidly. Moreover, as Internet personal broadcasting recently provides various and professional content, it has advanced to one format of a public airwaves entertainment program.

Personal broadcasting managed by a person may be compared with public airwaves broadcasting in many ways. One of the many ways is the number of cameras managed. That is, in this case, the number of cameras managed means how many cameras are managed in order to photograph a broadcasting program.

In general, in personal broadcasting by one person, one person who takes the lead of broadcasting performs broadcasting, and only one camera or a small number of cameras chiefly fixed to a monitor have to be used because a separate cameraman is not present. Accordingly, since an area photographed by a web camera is also fixed, it is a fact that there is a limit to the dynamic transfer of a scene or situation that wants to be shown by a user.

### DISCLOSURE

### Technical Problem

The present invention is for solving such a problem, and an object of the present invention is to provide an image transmission method, device and system based on a plurality of cameras, wherein a plurality of images is captured based on a plurality of cameras and an image to be transmitted can be selected and transmitted in response to a user's eyes.

### Technical Solution

In order to accomplish the object, in an aspect, the present invention provides an image transmission method based on a plurality of cameras. The image transmission method based on a plurality of cameras is an image transmission method being performed by an image transmission device, and includes the steps of obtaining a plurality of images using a plurality of cameras; segmenting a screen displayed on a monitor into a plurality of areas corresponding to the plurality of images and displaying the segmented screens; detecting an area watched by a user; selecting an image corresponding to the area detected in the step of detecting the area; and sending the selected image through broadcasting.

The plurality of cameras may include a main camera and at least one sub-camera, and the plurality of areas may include a main area in which an image captured by the main camera is displayed and at least one sub-area in which at least one image captured by the at least one sub-camera is displayed.

The step of selecting the image may include the step of selecting an image corresponding to an area which belongs to the plurality of areas corresponding to the plurality of images and which is watched by the user based on the area detected in the step of detecting the area.

The step of selecting the image may include the step of selecting an image which belongs to the plurality of images and which has been previously determined if it is detected that the user looks at an area other than the plurality of areas in the step of detecting the area.

The plurality of cameras may include a main camera provided in the middle of the top of the monitor; a first sub-camera provided at the top left end of the monitor; a second sub-camera provided at the top right end of the monitor; a third sub-camera provided at the bottom right end of the monitor; and a fourth sub-camera provided at the bottom left end of the monitor.

The plurality of areas may include a main area which is displayed in the central part of the screen of the monitor and in which an image obtained by the main camera is displayed; a first sub-area which is displayed in the upper left part of the screen of the monitor and in which an image obtained by the first sub-camera is displayed; a second sub-area which is displayed in the upper right part of the screen of the monitor and in which an image obtained by the second sub-camera is displayed; a third sub-area which is displayed in the lower right part of the screen of the monitor and in which an image obtained by the third sub-camera is displayed; and a fourth sub-area which is displayed in the lower left part of the screen of the monitor and in which an image obtained by the fourth sub-camera is displayed. The location of each of the cameras and the location of each of the areas displayed on the screen of the monitor may be matched.

At least one of the plurality of cameras may be fixed by a fixing device provided on one side of the monitor or a studio. The fixing device may include a fixing part fixed to one side of the monitor or the studio; an extension part formed to extend from the fixing part; and a support part provided on one side of the extension part and supporting the camera.

Meanwhile, in order to accomplish the object of the present invention, in another aspect, the present invention provides an image transmission device based on a plurality of cameras. The image transmission device based on a plurality of cameras may include an image reception unit receiving a plurality of images obtained by a plurality of cameras; a segmentation display unit segmenting a screen displayed on a monitor into a plurality of areas corresponding to the plurality of images and displaying the segmented screens; an eyes detection unit detecting an area watched by a user; an image selection unit selecting an image corresponding to the area detected by the eyes detection unit; and a transmission unit sending the image selected by the image selection unit through broadcasting.

The plurality of cameras may include a main camera and at least one sub-camera. The plurality of areas may include a main area in which an image captured by the main camera is displayed and at least one sub-area in which at least one image captured by the at least one sub-camera is displayed.

The image selection unit may select an image corresponding to an area which belongs to the plurality of areas corresponding to the plurality of images and which is watched by the user based on the detected area. The image selection unit may select an image which belongs to the plurality of images and which has been previously determined if it is detected that the user looks at an area other than the plurality of areas by the eyes detection unit.

The plurality of cameras may include a main camera provided in the middle of the top of the monitor; a first sub-camera provided at the top left end of the monitor; a second sub-camera provided at the top right end of the monitor; a third sub-camera provided at the bottom right end of the monitor; and a fourth sub-camera provided at the bottom left end of the monitor.

The plurality of areas may include a main area which is displayed in the central part of the screen of the monitor and in which an image obtained by the main camera is displayed; a first sub-area which is displayed in the upper left part of the screen of the monitor and in which an image obtained by the first sub-camera is displayed; a second sub-area which is displayed in the upper right part of the screen of the monitor and in which an image obtained by the second sub-camera is displayed; a third sub-area which is displayed in the lower right part of the screen of the monitor and in which an image obtained by the third sub-camera is displayed; and a fourth sub-area which is displayed in the lower left part of the screen of the monitor and in which an image obtained by the fourth sub-camera is displayed. The location of each of the cameras and the location of each of the areas displayed on the screen of the monitor may be matched.

At least one of the plurality of cameras may be fixed by a fixing device provided on one side of the monitor or a studio. The fixing device may include a fixing part fixed to one side of the monitor or the studio; an extension part formed to extend from the fixing part; and a support part provided on one side of the extension part and supporting the camera.

Meanwhile, in order to accomplish the object of the present invention, in yet another aspect, the present invention provides an image transmission system based on a plurality of cameras. The image transmission system based on a plurality of cameras may include a plurality of cameras obtaining a plurality of images; and an image transmission device receiving a plurality of images obtained by the plurality of cameras, segmenting a screen displayed on a monitor into a plurality of areas corresponding to the plurality of images and displaying the segmented screens, detecting an area watched by a user, selecting an image corresponding to the detected area, and sending the selected image through broadcasting.

The plurality of cameras may include a main camera and at least one sub-camera. The plurality of areas may include a main area in which an image captured by the main camera is displayed and at least one sub-area in which at least one image captured by the at least one sub-camera is displayed.

The image transmission device may select an image corresponding to an area which belongs to the plurality of areas corresponding to the plurality of images and which is watched by the user based on the detected area. The image transmission device may select an image which belongs to the plurality of images and which has been previously determined if it is detected that the user looks at an area other than the plurality of areas.

The plurality of cameras may include a main camera provided in the middle of the top of the monitor; a first sub-camera provided at the top left end of the monitor; a second sub-camera provided at the top right end of the monitor; a third sub-camera provided at the bottom right end of the monitor; and a fourth sub-camera provided at the bottom left end of the monitor.

The plurality of areas may include a main area which is displayed in the central part of the screen of the monitor and in which an image obtained by the main camera is displayed; a first sub-area which is displayed in the upper left part of the screen of the monitor and in which an image obtained by the first sub-camera is displayed; a second sub-area which is displayed in the upper right part of the screen of the monitor and in which an image obtained by the second sub-camera is displayed; a third sub-area which is displayed in the lower right part of the screen of the monitor and in which an image obtained by the third sub-camera is displayed; and a fourth sub-area which is displayed in the lower left part of the screen of the monitor and in which an image obtained by the fourth sub-camera is displayed. The location of each of the cameras and the location of each of the areas displayed on the screen of the monitor may be matched.

At least one of the plurality of cameras may be fixed by a fixing device provided on one side of the monitor or a studio. The fixing device may include a fixing part fixed to one side of the monitor or the studio; an extension part formed to extend from the fixing part; and a support part provided on one side of the extension part and supporting the camera.

Meanwhile, in order to accomplish the object of the present invention, in yet another aspect, the present invention provides an image transmission system. The image transmission system may include a plurality of cameras obtaining a plurality of images; and an image transmission device receiving the plurality of images obtained by the plurality of cameras, segmenting a screen displayed on a monitor into a plurality of areas corresponding to the plurality of images and displaying the segmented screens, and changing an image transmitted through broadcasting in response to a change of an area watched by a user in the plurality of areas based on the real-time detection of the user's eyes.

Meanwhile, in order to accomplish the object of the present invention, in yet another aspect, the present invention provides an image transmission device. The image transmission device is an image transmission device operating in conjunction with a plurality of cameras obtaining a plurality of images, and includes a first processing unit receiving the plurality of images obtained by the plurality of cameras, segmenting a screen displayed on a monitor into a plurality of areas corresponding to the plurality of images, and displaying the segmented screens; and a second processing unit changing an image transmitted through broadcasting in response to a change of an area watched by a user in the plurality of areas based on real-time detection of the user's eyes.

### Advantageous Effects

As described above, in accordance with the present invention, a plurality of images can be captured based on a plurality of cameras and an image to be transmitted can be automatically selected and transmitted in response to a user's eyes. For example, a transmission image can automatically switch in response to the eyes of a user who performs broadcasting. Accordingly, more dynamic broadcasting is made possible in personal broadcasting that is difficult to be equipped with an expensive camera equipment or transmission system.

### DESCRIPTION OF DRAWINGS

FIG. 1 is a block diagram showing the configuration of a system for realizing an image transmission method using a plurality of cameras according to a preferred embodiment of the present invention.

FIG. 2 is an exemplary diagram showing the locations where a plurality of cameras is disposed according to a preferred embodiment of the present invention.

FIG. 3 is a perspective view illustratively showing a fixing device for fixing a camera.

FIG. 4 is an exemplary diagram showing the locations where a plurality of cameras is disposed according to a preferred embodiment of the present invention.

FIG. 5 is a block diagram showing the configuration of an image transmission device shown in FIG. 1.

FIG. 6 is a flowchart for illustrating a flow of the image transmission device shown in FIG. 5 and shows a flow of an image transmission method according to a preferred embodiment of the present invention.

FIG. 7 is an exemplary diagram illustratively showing a screen of a monitor which is segmented by a segmentation display unit and displayed.

FIGS. 8 and 9 are exemplary diagrams for illustrating broadcasting content that moves in real time in response to a user's eyes.

### MODE FOR INVENTION

Hereinafter, preferred embodiments of the present invention are described in more detail with reference to the accompanying drawings. In describing the present invention, in order to facilitate general understanding, the same reference numerals are used to denote the same elements throughout the drawings, and a redundant description of the same elements is omitted.

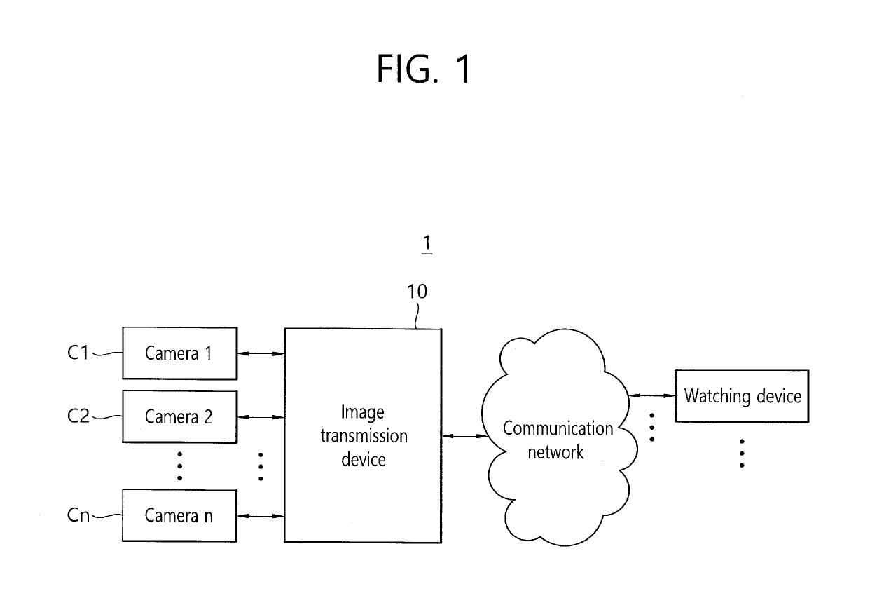

FIG. 1 is a block diagram showing the configuration of a system for realizing an image transmission method using a plurality of cameras according to a preferred embodiment of the present invention.

As shown in FIG. 1, the image transmission device 10 of the system 1 may operate in conjunction with a plurality of cameras C1˜Cn in a wired or wireless manner. The image transmission device 10 operates in conjunction with a communication network, such as the Internet, and may broadcast at least one of images obtained by the plurality of cameras C1˜Cn to a watching device over a communication network. A broadcasting service server may be included between the image transmission device 10 and the watching device.

The image transmission device 10 may operate in conjunction with n (n is an integer greater than 2) cameras C1˜Cn. For example, in a preferred embodiment of the present invention, the image transmission device 10 may operate in conjunction with five cameras. In this case, the five cameras may include one main camera and four sub-cameras. However, such an embodiment is not limited, and the number and roles of cameras may be changed and implemented in various ways. Each of the cameras may obtain an image and send the obtained image to the image transmission device 10 through a wired or wireless method.

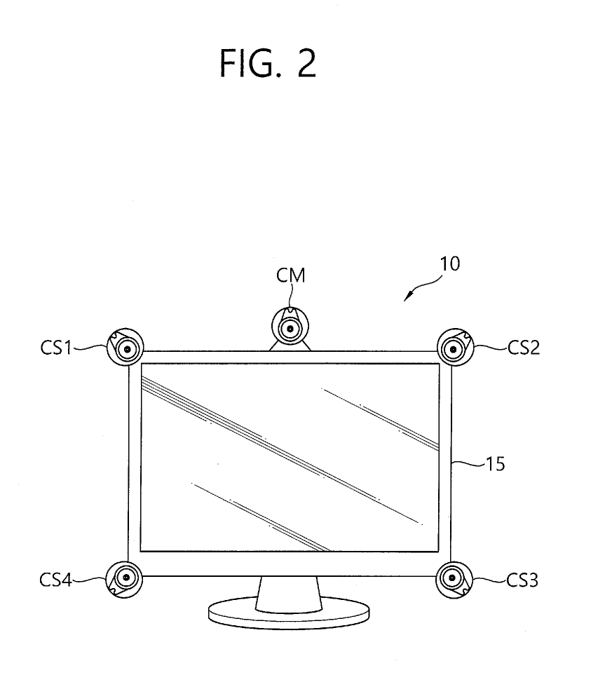

FIG. 2 is an exemplary diagram showing the locations where a plurality of cameras is disposed according to a preferred embodiment of the present invention.

As shown in FIG. 2, a main camera CM may be provided on one side of a monitor 15, for example, in the middle of the top of the monitor. A plurality of sub-cameras CS1˜CS4, for example, a sub-camera 1 CS1, a sub-camera 2 CS2, a sub-camera 3 CS3 and a sub-camera 4 CS4 may be provided on the other side of the monitor 15. For example, the sub-camera 1 CS1 may be provided at the top left end of the monitor 15. The sub-camera 2 CS2 may be provided at the top right end of the monitor 15. The sub-camera 3 CS3 may be provided at the bottom right end of the monitor 15. The sub-camera 4 CS4 may be provided at the bottom left end of the monitor 15.

Each of the cameras may be provided in the monitor 15 in an integrated form or may be fixed to the monitor 15 in a detachable form. Meanwhile, each of the cameras may be fixed at various locations of the monitor 15 or a studio through fixing means.

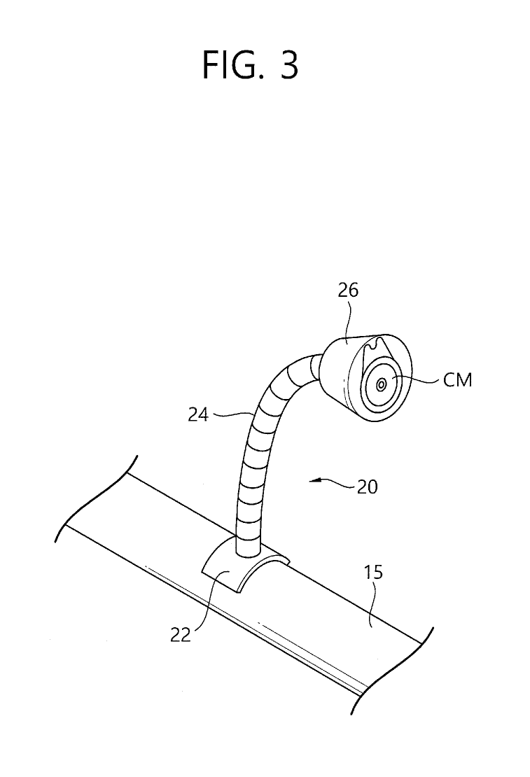

FIG. 3 is a perspective view illustratively showing a fixing device for fixing a camera. An example in which the camera shown in FIG. 3 is a main camera is described.

As shown in FIG. 3, the fixing device may include a fixing part 22 fixed to one side of the monitor 15 or a studio, an extension part 24 formed to extend from the fixing part 22, and a support part 26 which is provided at the end of the extension part 24 and supports the main camera CM.

The fixing part 22 may fix the fixing device to the monitor 15. The fixing part 22 may be formed to be detachable from the monitor 15 or a studio in a method, such as a compression type, a clamp type or an adhesive type. The support part 26 includes a unit in which a camera module can be seated, and can fix and support the camera module.

The extension part 24 connects the fixing part 22 and the support part 26 between them, and may enable the main camera CM to be extended from a fixed location. The extension part 24 may be flexibly modified in various length and directions and can support the main camera CM so that it has various angles of coverage.

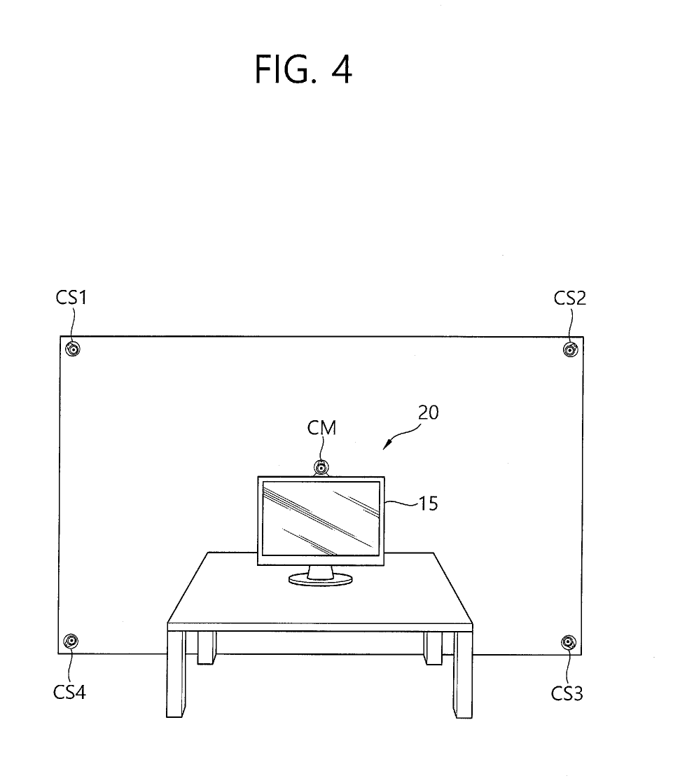

FIG. 4 is an exemplary diagram showing the locations where a plurality of cameras is disposed according to a preferred embodiment of the present invention, and shows an example in which the sub-cameras are mounted on a studio other than the monitor 15.

As shown in FIG. 4, the main camera CM may be provided in the middle of the top of the monitor 15. In contrast, the four sub-cameras CS1˜CS4 are installed on the surface of a wall of the front part of a studio. For example, the sub-camera 1 CS1 may be provided at the top left end of the surface of the wall of the studio. The sub-camera 2 CS2 may be provided at the top right end of the surface of the wall of the studio. The sub-camera 3 CS3 may be provided at the bottom right end of the surface of the wall of the studio. The sub-camera 4 CS4 may be provided at the bottom left end of the surface of the wall of the studio. An image of a wider range can be obtained because the sub-cameras CS1˜CS4 are installed on the surface of the wall of the studio as described above, as shown in FIG. 4.

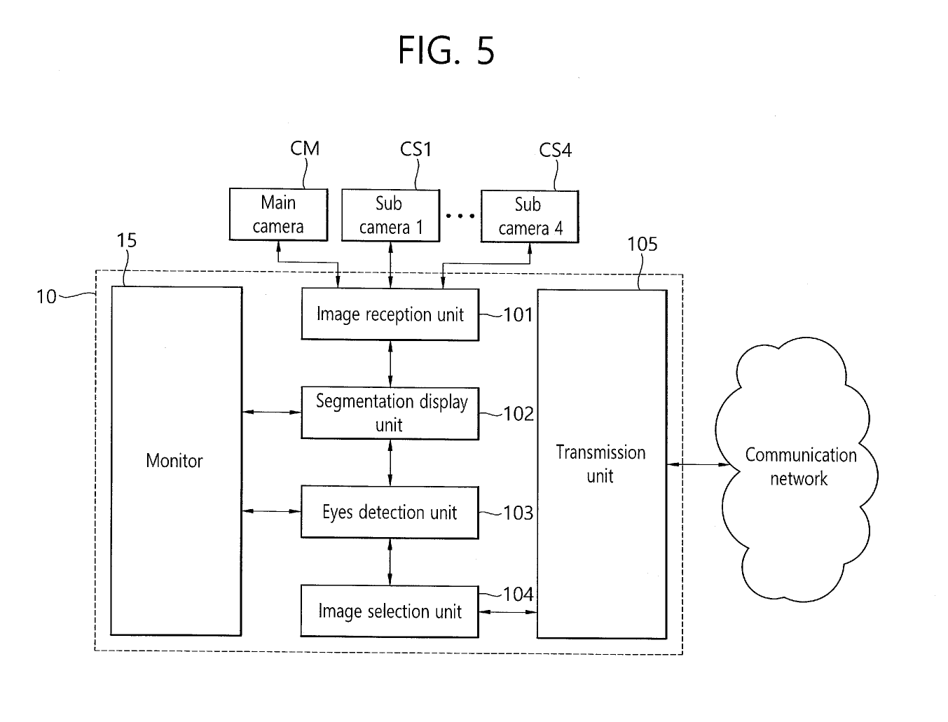

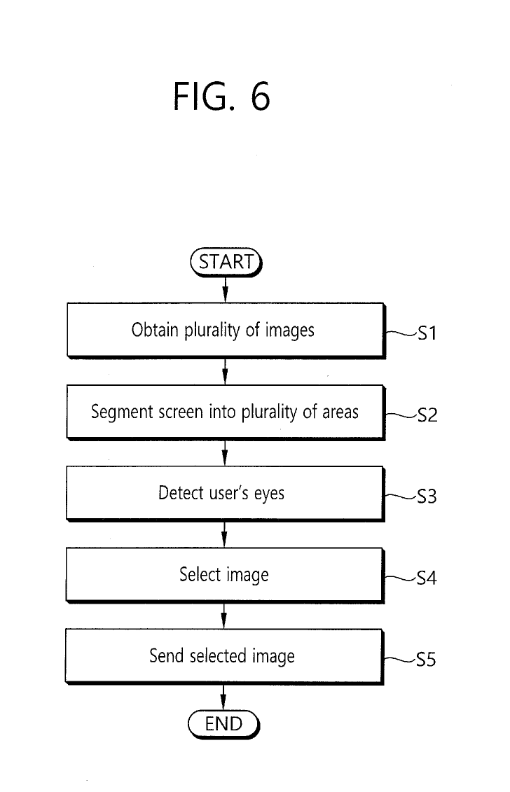

FIG. 5 is a block diagram showing the configuration of the image transmission device 10 shown in FIG. 1. FIG. 6 is a flowchart for illustrating a flow of the image transmission device 10 shown in FIG. 5 and shows a flow of an image transmission method according to a preferred embodiment of the present invention.

As shown in FIG. 5, the image transmission device 10 may include an image reception unit 101, a segmentation display unit 102, an eyes detection unit 103, an image selection unit 104, a transmission unit 105, the monitor 15, and so on. The image transmission device 10 may operate in conjunction with a plurality of cameras, for example, a main camera CM and four sub-cameras CS1˜CS4. On the other hand, the image transmission device 10 may provide a broadcasting service based on images captured by a plurality of cameras, for example, the main camera CM and the four sub-cameras CS1˜CS4 over a communication network.

Referring to FIGS. 5 and 6, the image reception unit 101 may obtain a plurality of images using the plurality of cameras CM and CS1˜CS4 (step: S1). For example, the image reception unit 101 may obtain a main image from the main camera CM, a sub-image 1 from the sub-camera 1 CS1, a sub-image 2 from the sub-camera 2 CS2, a sub-image 3 from the sub-camera 3 CS3, and a sub-image 4 from the sub-camera 4 CS4.

The segmentation display unit 102 may segment a screen displayed on the monitor 15 into a plurality of areas corresponding to the plurality of images and display the plurality of areas (step: S2). For example, the segmentation display unit 102 may segment a screen of the monitor 15 into five areas, such as a main area for displaying the main image obtained by the main camera CM, a sub-area 1 for displaying the sub-image 1 obtained by the sub-camera 1 CS1, a sub-area 2 for displaying the sub-image 2 obtained by the sub-camera 2 CS2, a sub-area 3 for displaying the sub-image 3 obtained by the sub-camera 3 CS3, and a sub-area 4 for displaying the sub-image 4 obtained by the sub-camera 4 CS4, and may display the segmented screens.

The segmentation display unit 102 may match the arrangements of a plurality of display areas on a screen of the monitor 15 in accordance with the actual physical arrangements of the plurality of cameras CM and CS1˜CS4. That is, the segmentation display unit 102 may arrange segmented display areas so that a user can intuitively recognize that a corresponding image has been captured by which camera by only watching the arrangements of segments areas on the screen of the monitor 15.

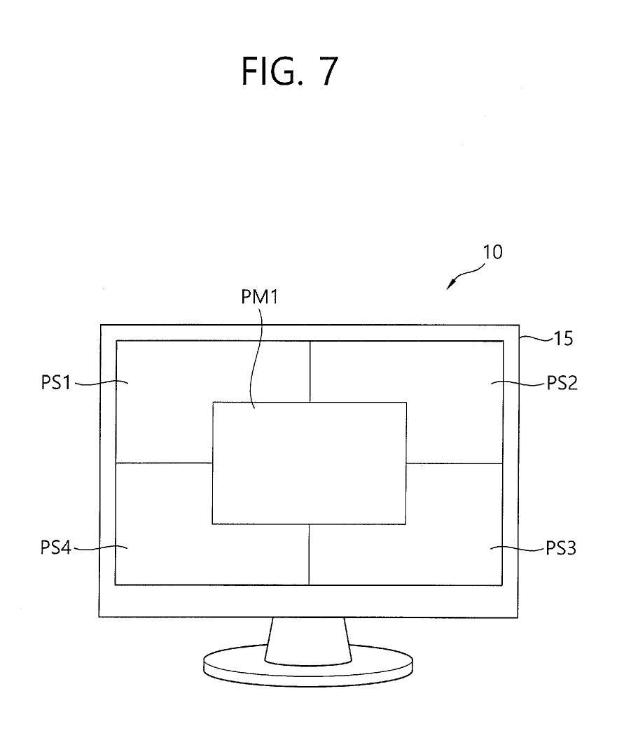

FIG. 7 is an exemplary diagram illustratively showing a screen of the monitor 15 which is segmented by the segmentation display unit 102 and displayed.

As shown in FIG. 7, for example, the main area PM1 for displaying the main image obtained by the main camera CM may be displayed in the central part of a screen. The sub-area 1 PS1 corresponding to the sub-camera 1 CS1, that is, the top left-side camera, may be displayed in the upper left part of the screen. The sub-area 2 PS2 corresponding to the sub-camera 2 CS2, that is, the top right-side camera, may be displayed in the upper right part of the screen. The sub-area 3 PS3 for displaying the sub-image 3 corresponding to the sub-camera 3 CS3, that is, the bottom right-side camera, may be displayed in the lower right part of the screen. The sub-area 4 CS4 for displaying the sub-image 4 obtained by the sub-camera 4 CS4, that is, the bottom left-side camera, may be displayed in the lower left part of the screen.

To this end, the segmentation display unit 102 may provide a user interface in which a user can set the locations and arrangements of display areas, and may automatically set the arrangements PM and PS1˜P54 of the display areas based on the arrangements of the plurality of cameras CM and CS1˜CS4.

For example, in the former case, when the plurality of cameras CM, CS1˜CS4 are connected, the segmentation display unit may recognize information about the number and IDs of the connected cameras and display a list of the connected cameras through a display area setting user interface. The display area setting user interface may display a real-time sample image corresponding to each of the cameras. The display area setting user interface may display various arrangements of display areas corresponding to the number of cameras, and may display a setting box that enables a user to select a required arrangement. When the selection of the arrangement is received through the setting box, the segmentation display unit 102 may set a camera arrangement in accordance with the received selection and may store setting data in a database.

Meanwhile, in the latter case, the image transmission device 10 may include a camera for photographing a wide angle. The segmentation display unit 102 may receive an image of a wide area through the camera for photographing a wide angle. When the plurality of cameras CM and CS1˜CS4 is connected, the segmentation display unit 102 may receive a plurality of images corresponding to the plurality of cameras, may compare the image obtained by each of the cameras with a previously received image of a wide area, and may analyze whether the image obtained by each of the cameras is matched up with which portion of the image of a wide area.

The segmentation display unit 102 may estimate the location of each of the cameras based on the comparison and matching and automatically set the location of a display area corresponding to each of the cameras based on the estimated location. If the matching between the image of a wide area and the image obtained by each of the cameras has not been normally performed, the segmentation display unit 102 may switch to a manual setting mode and display the area setting user interface.

In the state in which the plurality of images obtained by the plurality of cameras CM and CS1˜CS4 has been displayed on the screen of the monitor 15, the eyes detection unit 103 may sense an area being watched by a user by tracking the user's eyes (step: S3). The eyes detection unit 103 may include an eyes tracking sensor provided on one side of the monitor 15, for example. The eyes tracking sensor may be located in various ways depending on an implementation environment. For example, at least one of the main camera CM and the sub-cameras CS1˜CS4 also plays the role of an eyes tracking sensor.

When the area being watched by the user is sensed by the eyes detection unit 103, the image selection unit 104 may select an image corresponding to the area now detected as being watched by the user by the eyes detection unit 103 (step: S4). For example, if it is detected that the user looks at the main area PM on the screen of the monitor 15, the image selection unit 104 may select an image displayed in the main area PM, that is, an image obtained by the main camera CM. Alternatively, if it is detected that the user looks at the sub-area 1 PS1, the image selection unit 104 may select an image displayed in the sub-area 1 PS1, that is, an image obtained by the sub-camera 1 CS1.

Meanwhile, if the eyes detection unit 103 detects that the user looks at an area other than the plurality of display areas PM and PS1˜PS4, for example, the outside, back, etc. of the monitor 15 or the detection of the user's eyes is impossible, the image selection unit 104 may select an image that belongs to the plurality of images and that has been previously determined. For example, if the main image has been set as a default image and the user looks at the place other than the monitor 15 or looks aside or back, the image selection unit 104 may select the main image. The image selection unit 104 may previously set a user interface in which the default image can be set and set a default image in response to a signal selected through the user interface.

The transmission unit 105 may broadcast the image selected by the eyes detection unit 103 over a communication network. Accordingly, watching devices that receive an image served by the image transmission device 10 and play back the received image watch an image obtained by a camera corresponding to a display area that is now watched by the user.

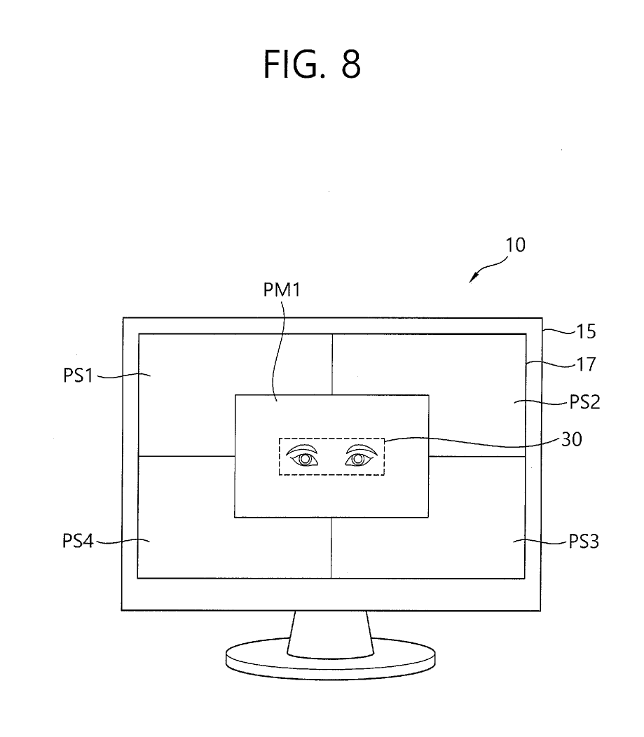

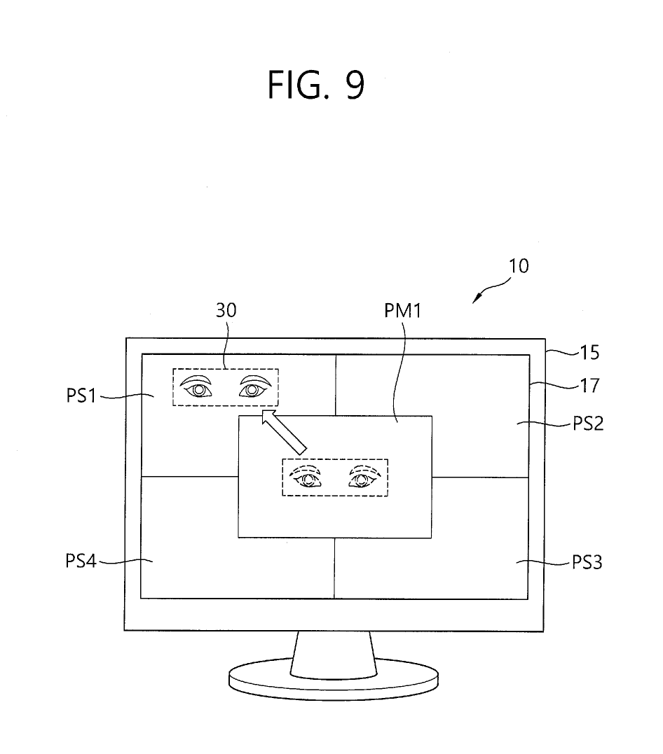

FIGS. 8 and 9 are exemplary diagrams for illustrating broadcasting content that moves in real time in response to a user's eyes.

As shown in FIG. 8, assuming that a user looks at the main area PM in the five display areas PM and PS1˜PS4 displayed on the monitor 15, the image transmission device 10 broadcasts an image obtained by the main camera CM corresponding to the main area PM.

As shown in FIG. 9, when the user's eyes move from the main area PM to the sub-area 1 PS1, the image transmission device 10 may select an image obtained by the sub-camera 1 CS1 and broadcast the selected image. Accordingly, the transmission of the image obtained by the main camera CM is stopped, and the image obtained by the sub-camera 1 CS1 is provided to the watching devices through broadcasting.

As described above, in accordance with the present invention, a plurality of images is obtained based on a plurality of cameras and a transmission image can automatically switch in real time in response to the eyes of a user who performs broadcasting. Accordingly, more dynamic broadcasting is made possible in personal broadcasting that is difficult to include an expensive camera equipment or transmission system.

Although the preferred embodiments of the present invention have been described above, those skilled in the art will appreciate that the present invention may be modified and changed in various ways without departing from the technological contents and scope of the present invention written in the appended claims. Accordingly, a change of the future embodiments of the present invention will not depart from the technology of the present invention.

1. An image transmission method based on a plurality of cameras, the image transmission method being performed by an image transmission device and comprising steps of:
obtaining a plurality of images using a plurality of cameras;
segmenting a screen displayed on a monitor into a plurality of areas corresponding to the plurality of images and displaying the segmented screens;
detecting an area watched by a user;
selecting an image corresponding to the area detected in the step of detecting the area; and
sending the selected image through broadcasting.

2. The image transmission method of claim 1, wherein:
the plurality of cameras comprises a main camera and at least one sub-camera, and
the plurality of areas comprises a main area in which an image captured by the main camera is displayed and at least one sub-area in which at least one image captured by the at least one sub-camera is displayed.

3. The image transmission method of claim 2, wherein the step of selecting the image comprises a step of selecting an image corresponding to an area which belongs to the plurality of areas corresponding to the plurality of images and which is watched by the user based on the area detected in the step of detecting the area.

4. The image transmission method of claim 2, wherein the step of selecting the image comprises a step of selecting an image which belongs to the plurality of images and which has been previously determined if it is detected that the user looks at an area other than the plurality of areas in the step of detecting the area.

5. The image transmission method of claim 1, wherein the plurality of cameras comprises:
a main camera provided in a middle of a top of the monitor;
a first sub-camera provided at a top left end of the monitor;
a second sub-camera provided at a top right end of the monitor;
a third sub-camera provided at a bottom right end of the monitor; and
a fourth sub-camera provided at a bottom left end of the monitor.

6. The image transmission method of claim 5, wherein the plurality of areas comprises:
a main area which is displayed in a central part of the screen of the monitor and in which an image obtained by the main camera is displayed;
a first sub-area which is displayed in an upper left part of the screen of the monitor and in which an image obtained by the first sub-camera is displayed;
a second sub-area which is displayed in an upper right part of the screen of the monitor and in which an image obtained by the second sub-camera is displayed;
a third sub-area which is displayed in a lower right part of the screen of the monitor and in which an image obtained by the third sub-camera is displayed; and
a fourth sub-area which is displayed in a lower left part of the screen of the monitor and in which an image obtained by the fourth sub-camera is displayed, and
a location of each of the cameras and a location of each of the areas displayed on the screen of the monitor are matched.

7. The image transmission method of claim 1, wherein:
at least one of the plurality of cameras is fixed by a fixing device provided on one side of the monitor or a studio, and
the fixing device comprises:
a fixing part fixed to one side of the monitor or the studio;
an extension part formed to extend from the fixing part; and
a support part provided on one side of the extension part and supporting the camera.

8. An image transmission device based on a plurality of cameras, comprising:
an image reception unit receiving a plurality of images obtained by a plurality of cameras;
a segmentation display unit segmenting a screen displayed on a monitor into a plurality of areas corresponding to the plurality of images and displaying the segmented screens;
an eyes detection unit detecting an area watched by a user;
an image selection unit selecting an image corresponding to the area detected by the eyes detection unit; and
a transmission unit sending the image selected by the image selection unit through broadcasting.

9. The image transmission device of claim 8, wherein:
the plurality of cameras comprises a main camera and at least one sub-camera, and
the plurality of areas comprises a main area in which an image captured by the main camera is displayed and at least one sub-area in which at least one image captured by the at least one sub-camera is displayed.

10. The image transmission device of claim 9, wherein the image selection unit selects an image corresponding to an area which belongs to the plurality of areas corresponding to the plurality of images and which is watched by the user based on the detected area.

11. The image transmission device of claim 8, wherein the image selection unit selects an image which belongs to the plurality of images and which has been previously determined if it is detected that the user looks at an area other than the plurality of areas by the eyes detection unit.

12. The image transmission device of claim 8, wherein the plurality of cameras comprises:
a main camera provided in a middle of a top of the monitor;
a first sub-camera provided at a top left end of the monitor;
a second sub-camera provided at a top right end of the monitor;
a third sub-camera provided at a bottom right end of the monitor; and
a fourth sub-camera provided at a bottom left end of the monitor.

13. The image transmission device of claim 12, wherein the plurality of areas comprises:
a main area which is displayed in a central part of the screen of the monitor and in which an image obtained by the main camera is displayed;
a first sub-area which is displayed in an upper left part of the screen of the monitor and in which an image obtained by the first sub-camera is displayed;
a second sub-area which is displayed in an upper right part of the screen of the monitor and in which an image obtained by the second sub-camera is displayed;
a third sub-area which is displayed in a lower right part of the screen of the monitor and in which an image obtained by the third sub-camera is displayed; and
a fourth sub-area which is displayed in a lower left part of the screen of the monitor and in which an image obtained by the fourth sub-camera is displayed, and
a location of each of the cameras and a location of each of the areas displayed on the screen of the monitor are matched.

14. The image transmission device of claim 8, wherein:
at least one of the plurality of cameras is fixed by a fixing device provided on one side of the monitor or a studio, and
the fixing device comprises:
a fixing part fixed to one side of the monitor or the studio;
an extension part formed to extend from the fixing part; and
a support part provided on one side of the extension part and supporting the camera.

15. An image transmission system based on a plurality of cameras, comprising:
a plurality of cameras obtaining a plurality of images; and
an image transmission device receiving a plurality of images obtained by the plurality of cameras, segmenting a screen displayed on a monitor into a plurality of areas corresponding to the plurality of images and displaying the segmented screens, detecting an area watched by a user, selecting an image corresponding to the detected area, and sending the selected image through broadcasting.

16. The image transmission system of claim 15, wherein:
the plurality of cameras comprises a main camera and at least one sub-camera, and
the plurality of areas comprises a main area in which an image captured by the main camera is displayed and at least one sub-area in which at least one image captured by the at least one sub-camera is displayed.

17. The image transmission system of claim 16, wherein the image transmission device selects an image corresponding to an area which belongs to the plurality of areas corresponding to the plurality of images and which is watched by the user based on the detected area.

18. The image transmission system of claim 15, wherein the image transmission device selects an image which belongs to the plurality of images and which has been previously determined if it is detected that the user looks at an area other than the plurality of areas.

19. The image transmission system of claim 15, wherein the plurality of cameras comprises:
a main camera provided in a middle of a top of the monitor;
a first sub-camera provided at a top left end of the monitor;
a second sub-camera provided at a top right end of the monitor;
a third sub-camera provided at a bottom right end of the monitor; and
a fourth sub-camera provided at a bottom left end of the monitor.

20. An image transmission device operating in conjunction with a plurality of cameras obtaining a plurality of images, the image transmission device comprising:
a first processing unit receiving the plurality of images obtained by the plurality of cameras, segmenting a screen displayed on a monitor into a plurality of areas corresponding to the plurality of images, and displaying the segmented screens; and
a second processing unit changing an image transmitted through broadcasting in response to a change of an area watched by a user in the plurality of areas based on real-time detection of the user's eyes.
